(19) United States
(12) Patent Application Publication
(10) Pub. No.: US 2009/0241298 A1
(43) Pub. Date: Oct. 1, 2009

(54) PRE-CUT SEAL FOR STRAP

(75) Inventor: Janusz Figiel, Mundelein, IL (US)

Correspondence Address: Levenfeld Pearlstein, LLC (ILLINOIS TOOL WORKS), 2 North LaSalle Street, Suite 1300, Chicago, IL, 60602, US

(73) Assignee: Illinois Tool Works Inc., Glenview, IL (US)

(21) Appl. No.: 12/398,828

(22) Filed: Mar. 5, 2009

Related U.S. Application Data
(60) Provisional application No. 61/041,295, filed on Apr. 1, 2008.

(51) Int. Cl. B65D 63/08; B23P 11/00

(52) U.S. Cl. 24/16 R; 29/592

(57) ABSTRACT

A seal has pre-cut slits formed in the seal body for securing the seal around a strap. The seal body has positioning tabs or a centering hole to position a hand tool to facilitate bending of the metal seal tabs defined by the pre-cut slits. The pre-cut seal is applied to overlapping sections of the strap and the seal tabs and strap ends are bent into an interlocking engagement sufficient to prevent withdrawal of the strap sections from the seal. A number of slits may be present in the seal depending on the size and shape of the seal, and the same number of slits may be formed on opposing sides of the seal. Different numbers of slits may also be formed, depending on the application. An inner surface of the seal may include a non-slip surface material such as grit or adhesive and/or may be formed with teeth or a knurled surface.

### CROSS-REFERENCE TO RELATED APPLICATION

This application claims the benefit of priority of Provisional U.S. Patent Application Ser. No. 61/041,295, filed Apr. 1, 2008, entitled “PRE-CUT SEAL FOR STRAP”.

### BACKGROUND OF THE INVENTION

The present invention is directed to a seal for strapping material. More particularly, the present invention pertains to a pre-cut seal for strapping material.

Packages are often bundled together with strapping material. The strapping material is typically an elongated strip of elastic or metal that is looped around the package and joined together at the ends. The ends are typically bound together with glue, friction sealing, or seal joints to ensure that the strap does not become loose.

One conventional means for securing the overlapping ends of a strap employs a metal seal that is deformed about the overlapping ends of the metal strap. Seals can be made from steel or other type of metal or polymer and can be used on a variety of strap material including plastic and metal strap. The strapping material ends are bound by placing the seal over the overlapping portions of the strap ends and crimping, notching or bending the edges of the seal to grasp the ends of the strap material together tightly.

A device used to crimp, notch, or bend the seal uses brute strength to either compress the seal or cut the seal to form a set of tabs which are then bent either up or down or in combination to hold the strap ends together. The seal not only holds the ends of the strap together, the seal also increases the strength of the strap joint at the seal.

Current seals are manufactured as rigid pieces of metal that are slightly folded to wrap around a strap material. While the seal's rigidity and relative lack of malleability results in a seal that strengthens joints and firmly holds strap material in place, the folded seal results in a double layer of material which needs to be cut and folded and thus, requires large hand tools and brute physical strength to crimp or bend the seal in place. Operators often apply much of their weight with both hands on the upper handle of a manual sealing device to cut and bend the seal.

Accordingly, it would be desirable to have a seal for strap which exhibits the same strength and rigidity of similar seals, but is also easier to manipulate and secure around strapping material.

### BRIEF SUMMARY OF THE INVENTION

A seal for strap has pre-cut slits formed in the seal body. The seal body has positioning tabs or a centering hole to position a hand tool to facilitate bending of the seal tabs defined by the pre-cut slits. The seal body may be formed from metal, polymer coated metal, or a plastic. A strap is looped around a package to overlap inner and outer and end portions of the strap. The pre-cut seal is applied to the overlapping end portions of the strap. The strap is positioned within the seal such that when the tabs of the seal are notched alternatingly along the sides of the seal, the strap is also notched alternatingly at the slits, producing an interlocking engagement sufficient to prevent withdrawal of the strap ends from the seal. Any number of slits may be present in the seal depending on the size and shape of the seal, and the same number of slits may be formed on opposing sides of the seal or different numbered slits may be formed, depending on the application.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of a pre-cut seal embodying the principles the present invention;

FIG. 2 is a perspective view of the pre-cut seal illustrating the joints formed in one embodiment;

FIG. 3 is a perspective view illustrating another embodiment of the pre-cut seal having positioning tabs;

FIG. 4 is a perspective view showing the bottom of the pre-cut seal;

FIG. 5 is a perspective view of an embodiment of the pre-cut seal having tabs alternately notched up;

FIG. 6 is a perspective view of an embodiment of the pre-cut seal having tabs alternately notched down;

FIG. 7 is a top view of an embodiment of a flat pre-cut seal having a centering hole; and

FIG. 8 is a cross-sectional view of the pre-cut seal, prior to notching.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

A pre-cut seal for strap includes a seal body, the seal body having a plurality of slits formed in at least one lateral portion of the seal body, the slits defining bendable tabs for securing the seal onto the strap. The pre-cut seal also includes positioning means, such as a center positioning hole formed in an upper surface of the seal body and configured to position a sealing device, a positioning tab formed at an end of the seal body and configured to position a sealing device, or a combination of the two. The seal body is formed from metal or polymer or a combination thereof The seal body is a tubular-like structure having an inner and an outer surface, and an upper surface and a lower surface, the tubular-like structure having an opening configured to allow the strap to pass therethrough. The slits are formed in at least one lateral portion or side of the seal body through the upper and the lower surfaces. Any number of slits may be present in the seal depending on the size and shape of the seal, and the same number of slits may be formed on opposing sides of the seal or a different number of slits may be formed, depending on the application. The inner surface has a non-slip surface, such as a non-slip material attached thereto or wherein grit or adhesive is attached thereto. In another embodiment, the inner surface is configured with a knurled surface. The tabs of the pre-cut seal are configured to engage the strap and provide an interlocking engagement configured to prevent withdrawal of the strap from the seal body.

The present pre-cut seal may be formed by providing a flattened cylindrical-like structure having a divide along a longitudinal length of the flattened cylindrical-like structure, providing slits in a folded edge of the cylindrical-like structure delineating tabs, and providing positioning means for a manual sealer, such as a centering hole or one or more positioning tabs. The pre-cut seal is applied to overlapping end portions of a strap and the seal's tabs and the strap ends are bent into an interlocking engagement sufficient to prevent withdrawal of the strap ends from the seal.

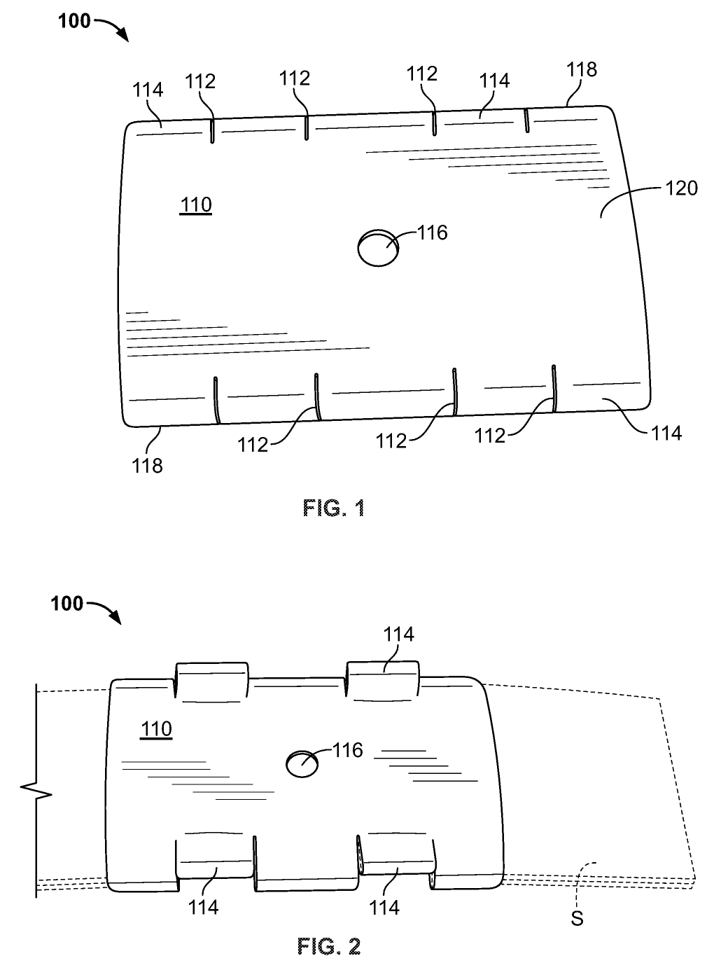

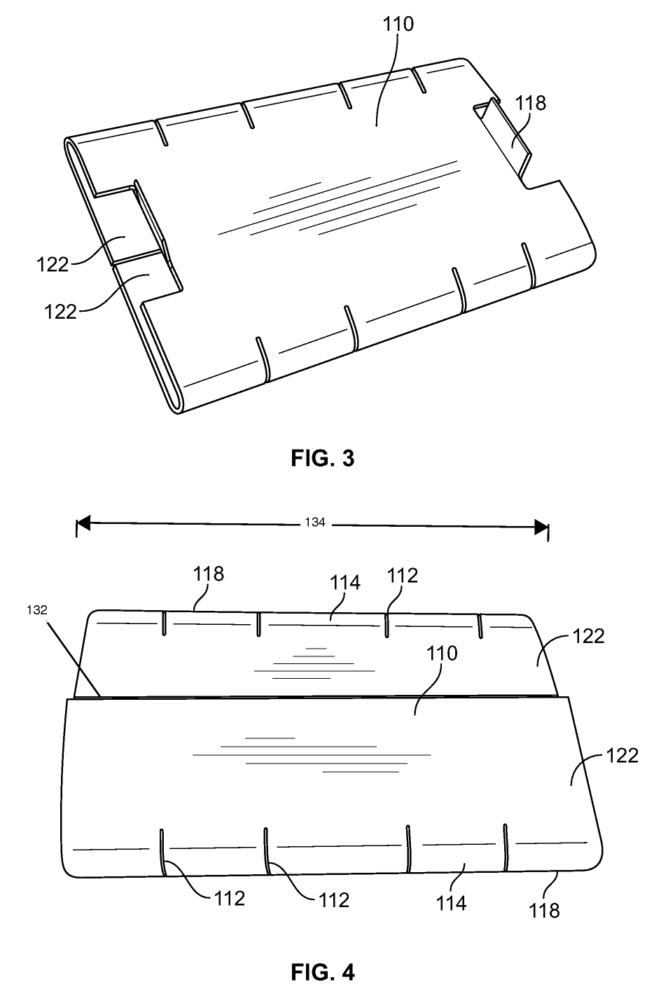

Referring now to the figures and in particular to FIGS. 1-4, there is shown a pre-cut seal 100 embodying the principles of the present invention. The seal 100 has a seal body 110, with eight (8) pre-cut slits 112 formed along lateral sides 118 of the body 110, four (4) on each side. The slits 112 delineate ten (10) tabs 114, five (5) on each lateral side of the seal body 110. While in the present embodiment eight slits 112 total are pre-cut into the body 110 of the seal 100, it is anticipated that any number of slits 112 may be formed depending on the application and the number of tabs desired to secure the strap. A centering hole 116 is located in approximately the center of the body 110 of the seal 100. The centering hole 116 is used to position a sealing device, such as single or double notch manual sealers, such as those available from ITW Signode of Glenview, Ill. In another embodiment, shown in FIG. 3, positioning tabs 18, located on opposing ends of the seal body 110 are used to position the manual sealer around the straps and seal body 110. A divide 132 along a longitudinal length 134 of the seal body allows the seal body to be manipulated around the strap.

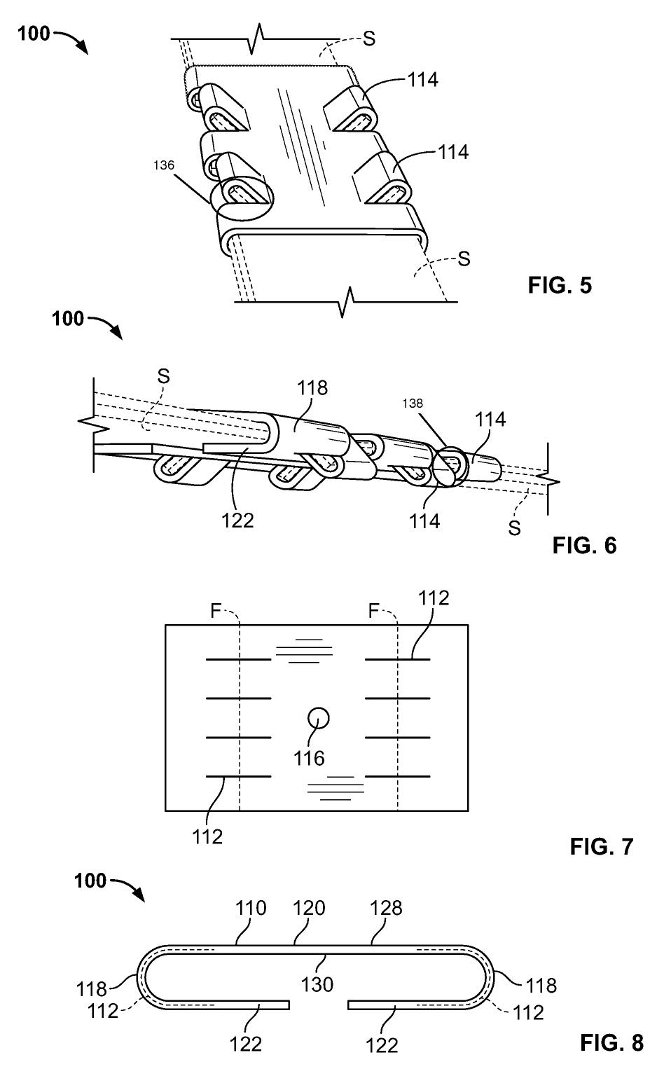

FIGS. 5 and 6 illustrate the pre-cut seal 100 in use on a section of strap material S. The seal body 110 is formed from a planar member of metal or other bendable material, such as a polymer material and preferably square or rectangular in shape, however other shapes are also contemplated. The seal 100 is placed over the overlapping strap ends, either before, during, or after tensioning of the strap S around the package. The tabs 114 of the seal body 110 formed by the pre-cut slits 112 are bent, or otherwise deformed, to form a notch joint to prevent withdrawal of the strap S from the seal 100. Notch joints 136, 138 mechanically lock the strapping ends together. With the seal 100 being pre-cut with slits 112, a sealing device or hand tool need only cut through the strapping material S to form one or two sets of tabs 114. The tabs 114 can be pushed up relative to a horizontal strap surface, as in FIG. 5, to form a reverse notch joint 136, or down relative to the strap surface, as in FIG. 6, to form a (down) notch joint, 138. Notch joints are typically used on waxed strapping S in packaging and unitizing applications and prevent sliding movement of the strap S.

It is anticipated that different configurations of seal 100 will be used. In one embodiment, the flanges 122 of the seal 100 are closed or slightly overlap, as shown in FIGS. 3 and 4. However, it is anticipated that flanges which are spaced slightly apart or in an “open” configuration may also be used. In addition, while one embodiment of the present pre-cut seal has a smooth interior surface, it is anticipated that the interior surface 130 of the pre-cut seal 100 may be coated with a substance, such as grit, adhesive, or other substance that forms a non-slip surface, to increase the frictional forces to provide increased holding power of the seal 100 onto the strap S. In an alternate embodiment, teeth or a knurled surface may be formed on the interior surface 130 of the seal 100 to grasp firmly the strap S and increase its holding power.

The seal body 110 is folded along fold lines F of opposing sides 118 forming an exterior surface 128 and an interior surface 130 with flanges 122, as shown in FIGS. 7 and 8. Slits 112 are cut/formed such that when the material of the seal 100 is folded along the fold lines F, the slits are positioned along a portion of the top 122, the sides 118, and through a portion of the lateral sides or flanges 122 of the seal body 110. The slits 112 in the seal body 110 may be formed prior to the bending of the flanges 122 or after. For example, slits 112 may be cut into a single layer, flattened metal sheet and then folded such that the slits 112 are folded onto itself forming a C-shaped profile, as shown in FIGS. 7 and 8. Alternatively, the slits 112 are formed after the material that forms the seal 100 is shaped into the C-profile and slits 112 are cut through two layers of material in the sides 118 of the seal 100.

The benefits of the presently claimed invention are numerous. For example, the pre-cut slits in the seal body eliminate the need for a user to cut slits into the seal body at the time of use in order to bend tabs around the strapping material. Having slits pre-cut into the seal body reduces the effort expended by an operator by up to fifty (50) percent, and may reduce, if not eliminate, the need for heavy, bulky hand tools or sealing devices.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A pre-cut seal for securing overlapping strap sections to one another, comprising:
a seal body, the seal body having a plurality of slits formed in at least one lateral portion of the seal body, the slits defining bendable tabs for securing the seal onto the overlapping strap sections.

2. The pre-cut seal of claim 1, further comprising:
a center positioning hole, the center positioning hole formed in an upper surface of the seal body and configured to position a sealing device.

3. The pre-cut seal of claim 1, further comprising:
one or more positioning tabs, wherein the one or more positioning tabs are formed at one or more ends of the seal body and configured to position a sealing device.

4. The pre-cut seal of claim 1 wherein the seal body is a tubular-like structure having an inner and an outer surface, and an upper surface and a lower surface, the tubular structure having an opening configured to allow the overlapping strap sections to pass therethrough.

5. The pre-cut seal of claim 4 wherein the plurality of slits are formed in the at least one lateral portion through the upper and the lower surfaces.

6. The pre-cut seal of claim 4 wherein the inner surface is a non-slip surface.

7. The pre-cut seal of claim 6 wherein the non-slip surface has grit, adhesive, or a non-stick material attached thereto.

8. The pre-cut seal of claim 4 wherein the inner surface is configured with a knurled surface.

9. The pre-cut seal of claim 1, wherein the seal body is formed from metal.

10. The pre-cut seal of claim 1, wherein the seal body is formed from plastic.

11. The pre-cut seal of claim 1, wherein the tabs are configured to engage the strap and provide an interlocking engagement configured to prevent withdrawal of one or both of the overlapping strap sections from the seal body.

12. A method of making a pre-cut seal for strap comprising:
providing a flattened cylindrical-like structure having a divide along a longitudinal length of the flattened cylindrical-like structure;
providing slits in a folded edge of the cylindrical-like structure delineating tabs; and
providing positioning means for a manual sealer.

13. The method of claim 12, wherein the positioning means is a centering hole.

14. The method of claim 12, wherein the positioning means is a positioning tab.
